(19) United States
(12) Patent Application Publication
(10) Pub. No.: US 2007/0122776 A1
(43) Pub. Date: May 31, 2007

(54) Method of learning arithmetic

(76) Inventor: Lori Stone, Winnetka, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/281,127

(22) Filed: Nov. 17, 2005

(51) Int. Cl. G09B 19/02

(52) U.S. Cl. 434/191

(57) ABSTRACT

A method and system are provided for learning arithmetic. The system includes a plurality of cards, each with one arithmetic problem on the front and an answer to the problem on the back. The front of the card includes a first number and a first graphical representation commonly associated with the first number and a second number and a second graphical representation commonly associated with the second number. The front may also include one or more clues to the answer to the problem. The back of the card includes a third number which is the solution to the arithmetic problem.

### FIELD OF THE INVENTION

This invention relates to teaching methods, and in more particular applications, to a method and system of teaching arithmetic.

### BACKGROUND OF THE INVENTION

In elementary school, children are expected to have master basic arithmetic skills. However, the mastery of such skills is often a difficult task for many youngsters. Children tend to be more concrete in their thinking and, therefore, often have trouble working with numbers, which requires abstract thinking.

Many devices have been used to teach arithmetic, for example, posters, flash cards, objects which can be manipulated (e.g., marbles), and more recently, video and computer games. In each of these approaches, an arithmetical question is posed (e.g., “3×3=?”) and then a numerical answer is given (e.g., “9”). Although there have been many variations upon these devices as a means to instruct children in basic arithmetical concepts, they remain a comparatively poor learning method because they fail to associate abstract numbers with concrete objects in a manner that facilitates accurate recall. Again, all of these variations utilize the basic technique of either teaching abstract numbers as such or teaching abstract numbers by equating them with a corresponding number of unrelated objects. This technique does not assist the child in remembering the sum, remainder, or product of two numbers other than through rote memorization or by counting on their fingers. In addition, young children typically have a limited attention span and become easily bored if their imagination is not stimulated. Posters, flash cards, objects, or video/computer games utilizing abstract numbers—even those containing pictorial representations of those numbers—fail to capture the imagination of most children for any length of time or encourage prolonged interaction with them because they are ultimately based on the memorization of abstract numerical facts.

### SUMMARY OF THE INVENTION

In accordance with one form of the invention, a learning method is provided. The method includes the step of conveying to an individual a first number or a suggestion of a first number, together with the identification of at least one of (a) at least one of a person, place or thing commonly associated with the first number and (b) a characteristic of at least one of a person, place or thing commonly associated with the first number. The method also includes the step of conveying to the individual a second number or a suggestion of a second number together with the identification of at least one of (a) at least one of a person, place or thing commonly associated with the second number and (b) a characteristic of at least one of a person, place or thing commonly associated with the second number. The method further includes the step of conveying to the individual one of (a) a suggestion of a third number and (b) the third number that is the result of a first arithmetic operation using the first and second numbers together with the identification of at least one of (a) at least one of a person, place or thing commonly associated with the third number and (b) a characteristic of at least one of a person, place or thing commonly associated with the third number.

In accordance with one form, the first and second numbers are the same.

In one form, the first and second numbers are different.

In one form, the method further includes the step of conveying to the individual one or more words suggesting the third number.

According to one form, the steps of conveying are performed through visual communication.

According to another form, the steps of conveying are also performed through auditory and/or tactile forms of communication.

According to one form, a learning method is provided. The method includes the step of conveying to an individual a first number through a first graphical representation commonly associated with the first number. The method further includes the step of conveying to the individual a symbol for a first arithmetic operation. The method also includes the step of conveying to the individual a second number through a second graphical representation commonly associated with the second number. The method further includes the step of conveying to the individual a word associated with at least one of the first and second graphical representations, the word containing information suggesting a result of performing the first arithmetic operation using the first and second numbers. The method also includes the step of conveying to the individual a third number that is the result of performing the first arithmetic operation using the first and second numbers.

In accordance with one form, the first graphical representation includes at least one of (a) at least one of a person, place or thing commonly associated with the first number and (b) a characteristic of at least one of a person, place or thing commonly associated with the first number.

According to one form, the second graphical representation includes at least one of (a) at least one of a person, place or thing commonly associated with the second number and (b) a characteristic of at least one of a person, place or thing commonly associated with the second number.

According to one form, the third number is conveyed through a third graphical representation commonly associated with the third number.

In one form, the first and second numbers are the same.

According to one form, the first and second numbers are different.

In accordance with one form, the first and second graphical representations are the same.

According to one form, the first and second graphical representations are different.

In one form, a system for learning arithmetic operations is provided. The system includes a plurality of cards. The cards each have a front side and a back side. The front side of a first card includes a first number together with a first graphical representation commonly associated with the first number, a second number together with a second graphical representation commonly associated with the second number, a symbol for a first arithmetic operation and a word associated with at least one of the first and second graphical representations, the word contains a clue suggesting a result of the first arithmetic operation. The back side of the first card includes a third number that is the result of performing the first arithmetic operation using the first and second numbers.

According to one form, the first and second numbers are the same.

In one form, the first and second numbers are different.

In accordance with one form, the first and second graphical representations are the same.

In one form, the first and second graphical representations are different.

Other objects, advantages, and features will become apparent from a complete review of the entire specification, including the appended claims and drawings.

### BRIEF DESCRIPTION OF THE DRAWINGS

FIG. 1 is a block diagram of a method depicting one embodiment of the present invention;

FIG. 2 is a flow diagram depicting the steps of an example using the present invention;

FIG. 3 is a block diagram of a method depicting another embodiment of the present invention;

FIG. 4a is a front face of a card in one embodiment of the present invention;

FIG. 4b is a back face of the card of FIG. 4a;

FIG. 5a is a front face of a card in another embodiment of the present invention; and

FIG. 5b is a back face of the card of FIG. 5a.

### DETAILED DESCRIPTION OF THE PREFERRED EMBODIMENTS

The present invention will be described hereinafter as a learning method and learning system such as a system including multi-sided cards. However, it should be understood that the invention is applicable to other learning methods, media and systems used in other contexts, for example, a learning system using computer software, video game software, or interactive DVD programs, as well as other printed media. Accordingly, no limitation to any particular use is intended except insofar as expressed in the appended claims.

The present method and system uses familiar persons, places, things, words and/or phrases commonly associated with numbers which are pictorially presented in a meaningful context, such as by presenting a story using the persons, places, things, words and/or phrases. The story may include mnemonic and other memory techniques to encourage learning and strengthen memory recall. Such a method and system may be suitable for children, who tend to conceptualize in concrete rather than in abstract terms, or for others who encounter difficulty in memorizing abstract numbers and equations.

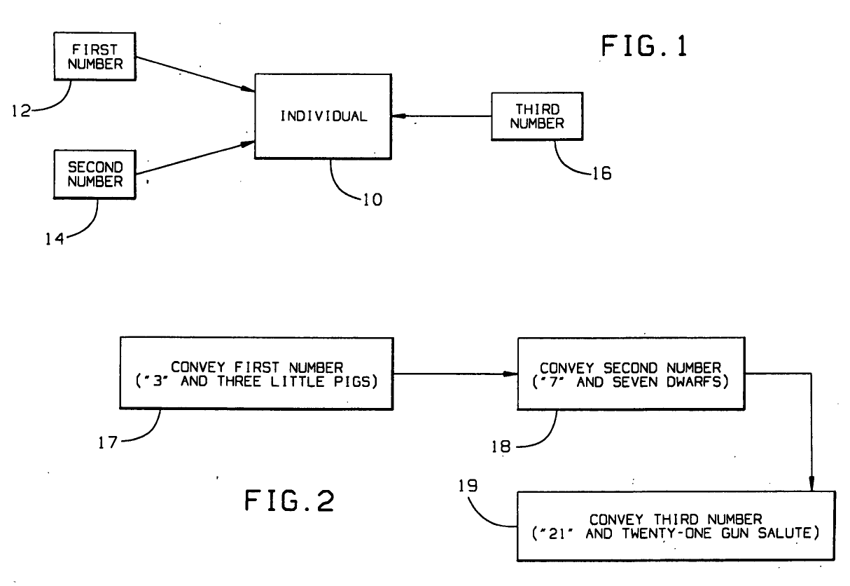

Referring to FIG. 1, one embodiment of the present learning method is shown. As shown in FIG. 1, a variety of information is conveyed to an individual 10. The method includes a step of conveying to the individual 10 a first number or a suggestion of a first number, together with the identification of at least one of (a) at least one of a person, place or thing commonly associated with the first number and (b) a characteristic of at least one of a person, place or thing commonly associated with the first number, as represented by box 12. The method also includes a step of conveying to the individual 10 a second number or a suggestion of a second number together with the identification of at least one of (a) at least one of a person, place or thing commonly associated with the second number and (b) a characteristic of at least one of a person, place or thing commonly associated with the second number, as represented by box 14. Additionally, the method includes a step of conveying to the individual one of a) a suggestion of a third number and b) the third number that is the result of a first arithmetic operation using the first and second numbers together with the identification of at least one of (a) at least one of a person, place or thing commonly associated with the third number and (b) a characteristic of at least one of a person, place or thing commonly associated with the third number, as represented by box 16.

As exemplified by box 12, this step includes conveying to the individual 10 a first number, such as any of the numbers 0-9 or numbers greater than 9, or a suggestion of the first number. The suggestion may include any number of representations that suggest the first number such as words, phrases, shapes or any other representation that brings to the individual's 10 mind the first number.

Furthermore, step 12 includes conveying the identification of at least one of (a) at least one of a person, place or thing commonly associated with the first number and (b) a characteristic of at least one of a person, place or thing commonly associated with the first number. The person, place, thing or characteristic is commonly associated with the first number, but may be either directly or indirectly associated. For example, suitable persons may include the seven dwarfs, which is commonly associated with the number seven. Similarly, suitable things include a four-leafed clover which is commonly associated with the number four or an eight ball which is associated with the number eight. Additionally, the “thing” may also include sounds, smells, and/or tactile objects that may be commonly associated with the number. The step 14 of conveying a second number or a suggestion of a second number may include similar persons, places, things or characteristics. The first and second numbers may be the same or different.

The method also includes the step 16 of conveying to the individual a suggestion of the third number and/or the third number itself. The third number is the result of an arithmetic operation using the first and second numbers. For example, suitable arithmetic operations include addition, subtraction, multiplication, division or other arithmetic operations. The step 16 also includes conveying at least one of (a) at least one of a person, place or thing commonly associated with the third number and (b) a characteristic of at least one of a person, place or thing commonly associated with the third number. The person, place, thing or characteristic may also be anything commonly associated with the third number, similar to those used for the first and second numbers.

For example, FIG. 2 depicts a flow diagram of one example of the above method. In a first step 17, the number “3” is conveyed along with “the three little pigs” which is commonly associated with the number “3.” In a second step 18, the number “7” is conveyed along with “the seven dwarfs” which is commonly associated with the number “7.” Finally, in a third step 19, the number “21” is conveyed, the result of multiplying “3” times “7”, along with a “twenty-one gun salute” which is commonly associated with the number “21.” It should be understood however, that these steps need not appear in this order.

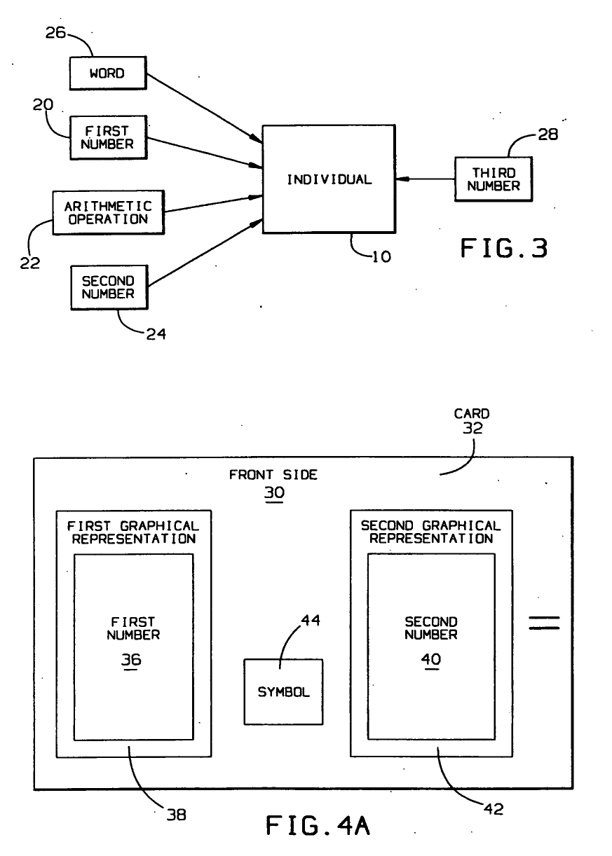

Referring to FIG. 3, another embodiment of the learning method is shown. This method includes the step of conveying to an individual 10 a first number through a first graphical representation commonly associated with the first number, as represented by box 20. The method also includes the step of conveying to the individual 10 a symbol for a first arithmetic operation, as represented by box 22. Further, the method includes the step of conveying to the individual 10 a second number through a second graphical representation commonly associated with the second number, as represented by box 24. The method also includes the step of conveying to the individual 10 a word associated with at least one of the first and second graphical representations, the word containing information suggesting a result of performing the first arithmetic operation using the first and second numbers, as represented by box 26. Furthermore, the method includes the step of conveying to the individual 10 a third number that is the result of performing the first arithmetic operation using the first and second numbers, as represented by box 28. The third number may also include a third graphical representation and/or word.

The first, second and third graphical representations can be any suitable visual presentation of information that is commonly associated with the first, second and third numbers. For example, the graphical representations may include people, places, things, characteristics, words, stories or other suitable visual presentations. These graphical representations will be discussed in detail below.

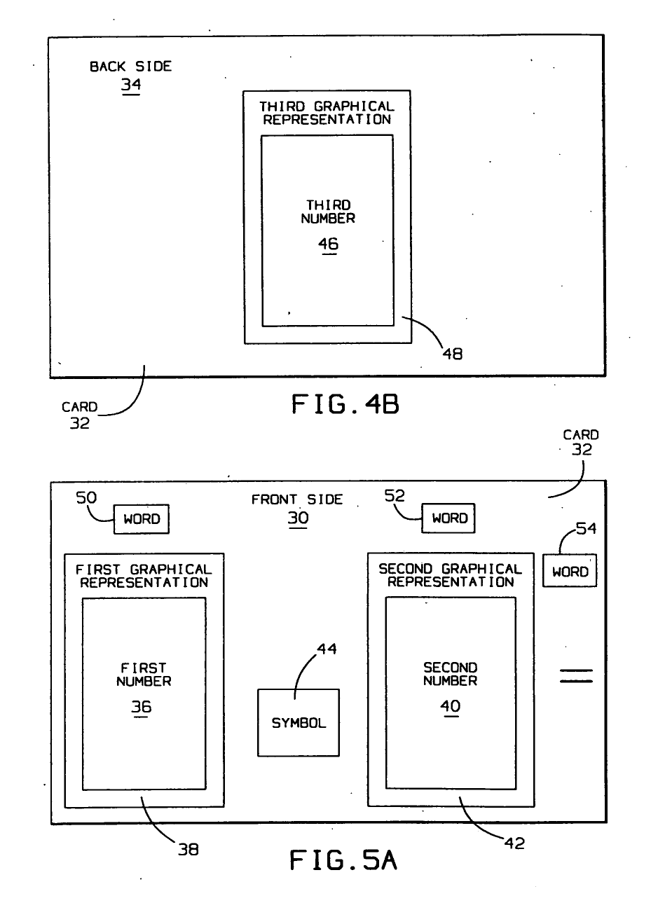

Another embodiment is shown in FIGS. 4a-b. In this embodiment, a system is provided for learning arithmetic operations. The system includes a plurality of cards. FIG. 4a shows a front side 30 of a card 32 while FIG. 4b shows a back side 34 of the card 32. The front side 30 includes a first number 36 together with a first graphical representation 38 that is commonly associated with the first number 36. The front side 30 also includes a second number 40 together with a second graphical representation 42 that is commonly associated with the second number 40. Additionally, the front side 30 includes a symbol 44 for a first arithmetic operation. The back side 34 of the card 32 includes a third number 46 that is the result of performing the first arithmetic operation using the first and second numbers. The back side 34 may also include a third graphical representation 48, as seen in FIG. 4b. It should be understood that the regions, such as the graphical representations 38 and 42, as well as the other regions shown in the figures are merely diagrammatic and the actual regions may take any shape, size or location on the card 32 or other medium.

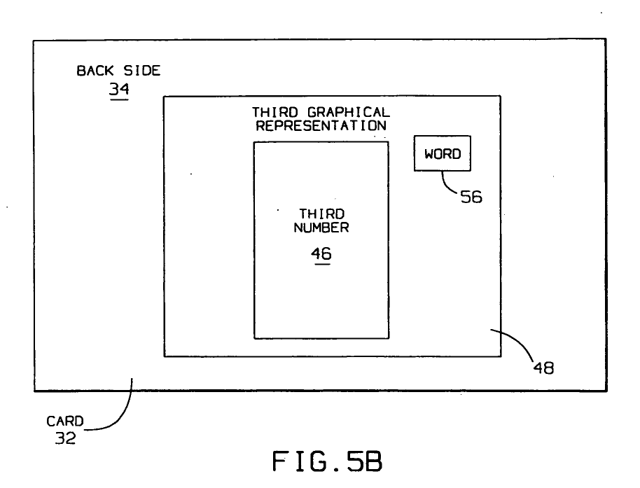

A further embodiment is shown in FIGS. 5a-b. This embodiment is similar to that shown in FIGS. 4a-b, but includes additional features. Specifically, in this embodiment, the card 32 includes at least one word. As shown in FIGS. 5a-b, the card 32 includes a word 50 associated with the first number 36, a word 52 associated with the second number 40, a word 54 suggesting the third number 46 and a word 56 associated with the third number 46. It should be understood by those skilled in the art that each of the words 50,52,54,56 may also include a plurality of words, a phrase, a sentence or the like. Furthermore it is not required to have all of the words 50,52,54,56 on the card 32. In some instances only one word, such as word 54 may be included on a card 32. However, it should be understood that any number and combination of words 50,52,54,56 may be included on the card 32.

The embodiments described above can be used as a learning method and/or system by an individual to learn a variety of arithmetic operations. The use of the numbers, such as the first, second and third numbers 36,40,46 can also be utilized to further reinforce the arithmetic operation. For example, the shape of the numbers can be used as mnemonic devices to suggest to the individual the answer to the problem or help them remember how to determine the answer.

Additionally, the use of a person, place, thing or characteristic can also further reinforce the arithmetic operation and/or solution to the problem. To even further reinforce remembering the answers to the arithmetic problems, the person, place, thing or characteristic may be the same for the same number throughout the entire plurality of cards or for the duration that the method is being used. For example, an eight ball may be associated with the number eight and used the entire duration that the method is used or used on all of the cards to represent the number eight. However, it is also contemplated that the person, place, thing or characteristic may change for the same number for the method or system.

The person, place, thing or characteristic may take the form of one of the graphical representations. The graphical representation may be located adjacent the respective number or even superimposed in front of or behind the respective number as diagrammatically shown in FIGS. 4a-b and 5a-b. However, it should be understood that the person, place, thing or characteristic may be located anywhere.

The graphical representations themselves may include a variety of shapes, people, places, things, characteristics and the like to further reinforce the arithmetic problem. The graphical representations may include a two-faced character for representing the number two, the three little pigs for representing the number three, a four leafed clover for representing the number four and so on.

Additionally, the graphical representations may include a variety of colors that are appealing to the individual. For example, bright colors may be used to attract the individual's attention to certain aspects of the graphical representation. Furthermore, the graphical representations may include humorous sketches, action, absurd scenarios and the like that will firther attract the individual's attention.

The numbers 36,40, graphical representations 38,42 and/or the words 50,52,54,56 may be used to create a story associated with the arithmetic operation for each individual card. The stories can be used to reinforce the arithmetic operation or provide a mnemonic device for remembering the solution to the problem. In addition to using stories, the cards can also include rhymes. Such devices are powerful memory techniques which have been shown to enhance recall. Furthermore, such devices help provide additional interaction for the individual with the method and system.

Additional devices may be used to help the individual determine the answer to the arithmetic operation and problem. For example, clues or suggestions can be used to lead the user toward the correct answer. One such type of clue would be using word phrases such as “one for the money” where the words “one for” may be indicative of the answer of fourteen. Furthermore, these clues may be set off from the other text and/or graphical representations shown on the faces of the cards. For example, the clues or suggestions may be highlighted in a different color, such as red, than the remaining text which may be black.

The graphical representations, words and clues may all be used as part of a story for each card and each arithmetic operation. For example, all of these devices may be used in the arithmetic operation of two multiplied times seven to give an answer of fourteen. This card could include a front side having the numbers two and seven and a graphical representation of a two-faced character interacting with a graphical representation of the seven dwarfs mining for gold. There may be text such as “one for the money, two for the show, three to get ready, four to . . . gold.” The text “one for” may be displayed in red text whereas all of the remaining text may be black. The back side of the card could include the number fourteen shaped and designed out of bricks of gold with further graphical representations of fourteen-karat gold. The story as well as the associated graphical representations and clues can reinforce this particular arithmetic operation for the individual. Similar stories and cards can be designed for a variety of other numbers and arithmetic operations. Overall, the method and system can include a variety of devices as outlined above to maintain the interest of the individual as well as increase recall.

Though described above as a method and system including a plurality of cards, the present invention may take a variety of other forms that have also been contemplated. For example, instead of using physical cards or other printed media, the method and system may be embodied on an electronic screen, such as a computer monitor or television. For example, the method and system may be embodied in software that can be used on a computer by an individual. The software may be interactive requiring input from the individual to progress from the problem to the answer as well as to progress to the next problem. Similarly, the method and system may be embodied on an interactive video, such as found on DVDs or video games. The DVD may require interaction from the user to progress from the problem to the answer as well as to progree to the next problem. The software, video games and/or DVD may include additional features such as music, sounds and voices. The voices may be used to read the text that is shown on the screen. The voices may also provide additional information beyond what is found on the screen.

1. A learning method comprising the steps of:
conveying to an individual a first number or a suggestion of a first number, together with the identification of at least one of (a) at least one of a person, place or thing commonly associated with the first number and (b) a characteristic of at least one of a person, place or thing commonly associated with the first number;
conveying to the individual a second number or a suggestion of a second number together with the identification of at least one of (a) at least one of a person, place or thing commonly associated with the second number and (b) a characteristic of at least one of a person, place or thing commonly associated with the second number; and
conveying to the individual one of a) a suggestion of a third number and b) the third number that is the result of a first arithmetic operation using the first and second numbers together with the identification of at least one of (a) at least one of a person, place or thing commonly associated with the third number and (b) a characteristic of at least one of a person, place or thing commonly associated with the third number.

2. The learning method according to claim 1 wherein the first and second numbers are the same.

3. The learning method according to claim 1 wherein the first and second numbers are different.

4. The learning method according to claim 1 further comprising the step of conveying to the individual one or more words suggesting the third number.

5. The learning method according to claim 1 wherein the steps of conveying are performed through visual communication.

6. A learning method comprising the steps of:
conveying to an individual a first number through a first graphical representation commonly associated with the first number;
conveying to the individual a symbol for a first arithmetic operation;
conveying to the individual a second number through a second graphical representation commonly associated with the second number;
conveying to the individual a word associated with at least one of the first and second graphical representations, the word containing information suggesting a result of performing the first arithmetic operation using the first and second numbers; and
conveying to the individual a third number that is the result of performing the first arithmetic operation using the first and second numbers.

7. The learning method of claim 6 wherein the first graphical representation includes at least one of (a) at least one of a person, place or thing commonly associated with the first number and (b) a characteristic of at least one of a person, place or thing commonly associated with the first number.

8. The learning method of claim 7 wherein the second graphical representation includes at least one of (a) at least one of a person, place or thing commonly associated with the second number and (b) a characteristic of at least one of a person, place or thing commonly associated with the second number.

9. The learning method of claim 6 wherein the first and second numbers are the same.

10. The learning method of claim 6 wherein the first and second numbers are the different.

11. The learning method of claim 6 wherein the first and second graphical representations are the same.

12. The learning method of claim 6 wherein the first and second graphical representations are different.

13. A system for learning arithmetic operations, the system comprising:
a plurality of cards,
the cards each having a front side and a back side,
the front side of a first card including a first number together with a first graphical representation commonly associated with the first number, a second number together with a second graphical representation commonly associated with the second number, a symbol for a first arithmetic operation and a word associated with at least one of the first and second graphical representations, the word containing a clue suggesting a result of the first arithmetic operation,
the back side of the first card including a third number that is the result of performing the first arithmetic operation using the first and second numbers.

14. The system of claim 13 wherein the first and second numbers are the same.

15. The system of claim 13 wherein the first and second numbers are the different.

16. The system of claim 13 wherein the first and second graphical representations are the same.

17. The system of claim 13 wherein the first and second graphical representations are different.
